(19) United States
(12) Patent Application Publication
(10) Pub. No.: US 2014/0125536 A1
(43) Pub. Date: May 8, 2014

(54) COMMUNICATION DEVICE AND WIDE-BAND ANTENNA ELEMENT THEREIN

(71) Applicant: ACER INCORPORATED, Taipei Hsien (TW)

(72) Inventors: Kin-Lu WONG, Kaohsiung City (TW); Fang-Hsien CHU, Kaohsiung City (TW)

(73) Assignee: ACER INCORPORATED, Taipei Hsien (TW)

(21) Appl. No.: 13/732,689

(22) Filed: Jan. 2, 2013

(30) Foreign Application Priority Data
Nov. 5, 2012 (TW) 101140941

(51) Int. Cl. H01Q 5/00

(52) U.S. Cl. CPC H01Q 5/0034
USPC 343/749

(57) ABSTRACT

A communication device including a ground element and an antenna element is provided. The antenna element is disposed adjacent to the ground element. The antenna element includes a first radiation element and a second radiation element. The first radiation element includes a first portion and a second portion. The first portion is coupled through an inductive element to the second portion. The first portion is coupled to a signal source. The second portion includes a plurality of bends such that a coupling gap is formed between an open end of the second portion and the first portion. The second radiation element has a shorted end and an open end. The shorted end of the second radiation element is coupled to the ground element. The second radiation element extends and at least partially surrounds the first radiation element.

### CROSS REFERENCE TO RELATED APPLICATIONS

This Application claims priority of Taiwan Patent Application No. 101140941 filed on Nov. 5, 2012, the entirety of which is incorporated by reference herein.

### BACKGROUND OF THE INVENTION

1. Field of the Invention

The disclosure generally relates to a communication device, and more particularly, relates to a communication device comprising a wide-band antenna element.

2. Description of the Related Art

With recent, rapid development in wireless communication technology, a variety of wireless communication devices have been developed and marketed. Among them, the most popular are mobile communication devices. To satisfy the demands for a slim profile and multiple functions, available space in mobile communication devices to accommodate internal antennas is becoming very limited. It is hence a challenge for an antenna designer to effectively use limited internal space of a mobile communication device to design antennas therein.

In particular, current mobile communication devices require WWAN (Wireless Wide Area Network) and LTE (Long Term Evolution) systems, in which a compact antenna element should operate in dual wide bands. This is a critical challenge for an antenna designer.

Accordingly, there is a need to design a novel communication device and an antenna element therein. The antenna element should operate in at least two wide bands. The antenna element should have a small-size, simple-design structure with high radiation efficiency, and be suitably configured to cover WWAN/LTE multiple bands.

### BRIEF SUMMARY OF THE INVENTION

The invention is aimed to provide a communication device comprising a wide-band antenna element. Note that the wide-band operation of the antenna element does not lead to an increase of the total size of the antenna element. In addition, the antenna element can maintain high radiation efficiency in the required operation bands.

In a preferred embodiment, the invention provides a communication device, comprising: a ground element; and an antenna element, disposed adjacent to the ground element, wherein the antenna element comprises: a first radiation element, comprising a first portion and a second portion, wherein the first portion is coupled through an inductive element to the second portion, the first portion is coupled to a signal source, the second portion comprises a plurality of bends such that a coupling gap is formed between an open end of the second portion and the first portion; and a second radiation element, wherein the second radiation element has a shorted end and an open end, the shorted end is coupled to the ground element, and the second radiation element extends and at least partially surrounds the first radiation element.

In some embodiments, the antenna element of the communication device can operate in WWAN/LTE (Wireless Wide Area Network/Long Term Evolution) bands. The first radiation element is configured to generate a resonant mode at about 850 MHz. However, since the total size of the antenna element has been decreased, the resonant mode of the first radiation element generally cannot cover a desired lower band. In some embodiments, the plurality of bends of the second portion of the first radiation element generate an effective inductance, and the coupling gap between the second portion and the first portion of the first radiation element generates an effective capacitance. Owing to the effective inductance and the effective capacitance, the antenna element can generate a parallel resonance near the lower band. The design leads to an additional resonant mode in the lower band of the antenna element, and the antenna element can achieve wide-band operation of the lower band.

Note that the second portion of the first radiation element is located inside of the antenna element and that the open end of the second portion is substantially located between the first portion and the ground element. Accordingly, the total size of the antenna element is not increased.

In some embodiments, the second portion is coupled through an inductive element (e.g., a chip inductor) in series to the first portion. When the antenna element operates in a higher band, high impedance of the inductive element is considered as an open circuit such that the second portion does not affect operation of the higher band of the antenna element.

In some embodiments, the bends of the second portion of the first radiation element cause the second portion to comprise a first segment, a second segment and a third segment. The first segment is substantially parallel to the third segment, and the second segment is substantially perpendicular to the first segment and the third segment.

In some embodiments, when the antenna element operates in a higher band, the second radiation element generates a higher-order resonant mode, and the first portion of the first radiation element generates a resonant mode. The two resonant modes are close to each other to form a wide band (generally, the bandwidth of the wide band is greater than 1 GHz). The antenna element of the invention can cover at least dual wide bands, and the total size thereof is decreased. In a preferred embodiment, the antenna element of the invention is suitably applied to WWAN/LTE multiple bands, and the antenna element can maintain high radiation efficiency in the required operation bands.

### BRIEF DESCRIPTION OF DRAWINGS

The invention can be more fully understood by reading the subsequent detailed description and examples with references made to the accompanying drawings, wherein:

FIG. 1 is a diagram for illustrating a communication device according to a first embodiment of the invention;

FIG. 2 is a diagram for illustrating return loss of an antenna element of a communication device according to a first embodiment of the invention;

FIG. 3 is a diagram for illustrating antenna efficiency of an antenna element of a communication device according to a first embodiment of the invention;

FIG. 4 is a diagram for illustrating a communication device according to a second embodiment of the invention;

FIG. 5 is a diagram for illustrating a communication device according to a third embodiment of the invention; and

FIG. 6 is a diagram for illustrating a communication device according to a fourth embodiment of the invention.

### DETAILED DESCRIPTION OF THE INVENTION

In order to illustrate the foregoing and other purposes, features and advantages of the invention, the embodiments and figures thereof in the invention are described in detail as follows.

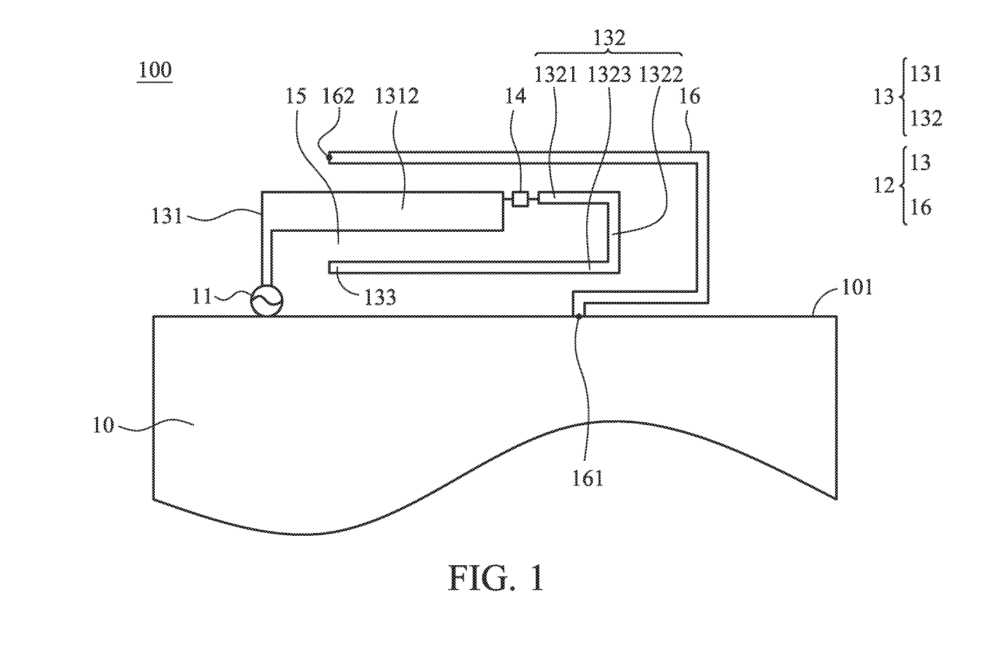

FIG. 1 is a diagram for illustrating a communication device 100 according to a first embodiment of the invention. The communication device 100 may be a mobile phone, a tablet computer, or a notebook computer. In the first embodiment, the communication device 100 comprises a ground element 10 and an antenna element 12. The antenna element 12 is disposed adjacent to the ground element 10. The antenna element 12 comprises a first radiation element 13 and a second radiation element 16. The first radiation element 13 comprises a first portion 131 and a second portion 132. The first portion 131 is coupled through an inductive element 14 in series to the second portion 132. In some embodiments, the inductive element 14 is a chip inductor. An end of the first portion 131 is coupled to a signal source 11. The second portion 132 comprises a plurality of bends such that a coupling gap 15 is formed between an open end 133 of the second portion 132 and the first portion 131. More particularly, the bends of the second portion 132 cause the second portion 132 to comprise a first segment 1321, a second segment 1322 and a third segment 1323. The first segment 1321 is substantially parallel to the third segment 1323, and the second segment 1322 is substantially perpendicular to the first segment 1321 and the third segment 1323. The second radiation element 16 has a shorted end 161 and an open end 162. The shorted end 161 of the second radiation element 16 is coupled to the ground element 10. The second radiation element 16 extends and at least partially surrounds the first radiation element 13. The first portion 131 comprises at least one bend such that at least one segment 1312 of the first portion 131 is substantially parallel to an edge 101 of the ground element 10. The first portion 131 may substantially have an inverted L-shape, and the second portion 132 may substantially have an inverted J-shape. The open end 133 of the second portion 132 is substantially located between the first portion 131 and the ground element 10. In a preferred embodiment, the length of the second portion 132 is greater than a half of the length of the first portion 131 such that the second portion 132 can provide a sufficient inductance. The length of the second radiation element 16 is greater than the length of the first portion 131 such that each of the second radiation element 16 and the first portion 131 generates a fundamental resonant mode. The two fundamental resonant modes are located in a lower band and a higher band of the antenna element 12, respectively, and accordingly the antenna element 12 can achieve WWAN/LTE dual-band operation. Note that the communication device 100 may further comprise other essential components, for example, a processor, a touch panel, a battery, and a housing (not shown).

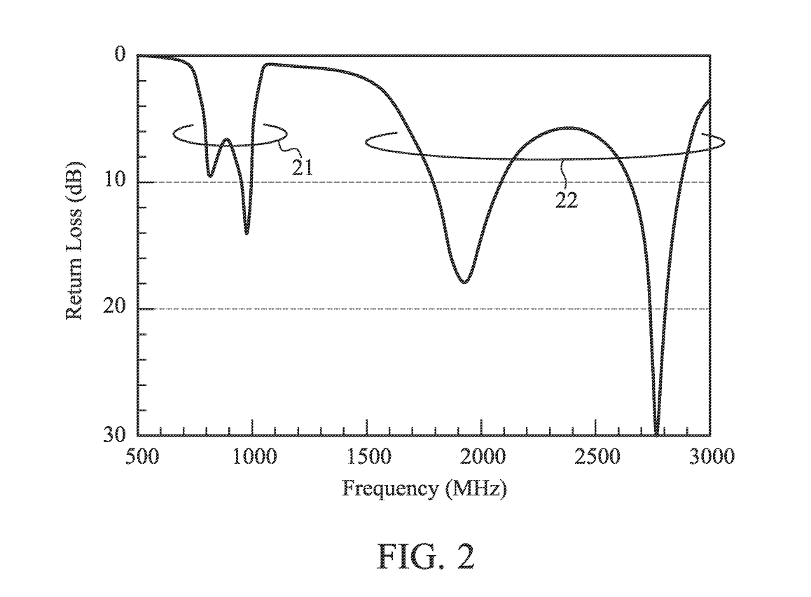

FIG. 2 is a diagram for illustrating return loss of the antenna element 12 of the communication device 100 according to the first embodiment of the invention. In some embodiments, the element sizes and the element parameters of the communication device 100 are as follows. The ground element 10 has a length of about 115 mm and a width of about 60 mm. The antenna element 12 substantially has a planar structure. The antenna element 12 has a length of about 30 mm and a width of about 12 mm. The second radiation element 16 has a length of about 56 mm. The second portion 132 of the first radiation element 13 has a length of about 29 mm. The inductive element 14 is a chip inductor with an inductance of about 15 nH. According to 6 dB return loss (the criterion of antenna design in mobile communication devices), the antenna element 12 can operate in at least a first band 21 and a second band 22. In a preferred embodiment, the first band 21 has a wide bandwidth to cover at least GSM850/900 bands (from about 824 MHz to 960 MHz), and the second band 22 has another wide bandwidth to cover at least GSM1800/1900/UMTS/LTE2300/2500 (from about 1710 to 2690 MHz). Accordingly, the antenna element 12 of the invention can cover the requirement for WWAN/LTE multiple bands. Note that the above element sizes, element parameters and frequency ranges are not limitations of the invention. A designer can adjust the element sizes, element parameters and frequency ranges according to different desires.

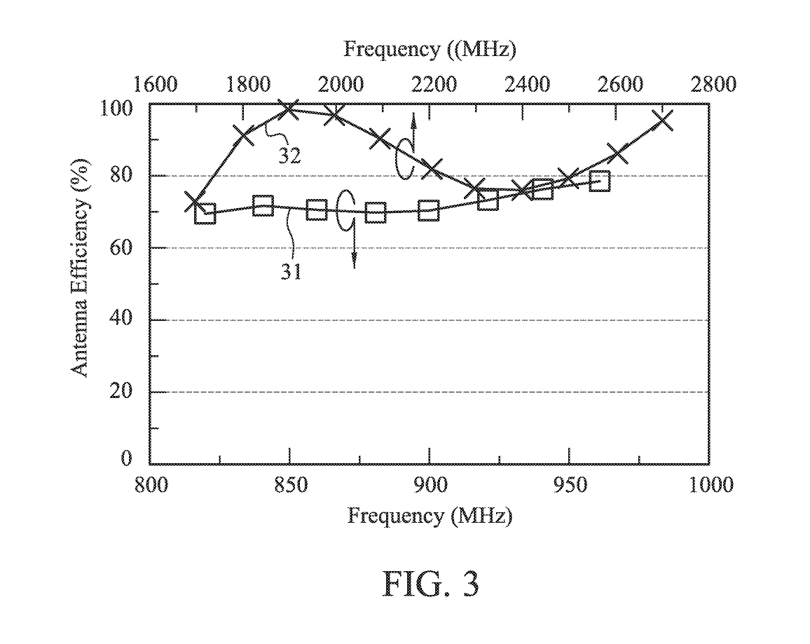

FIG. 3 is a diagram for illustrating antenna efficiency of the antenna element 12 of the communication device 100 according to the first embodiment of the invention. The antenna efficiency curve 31 represents the antenna efficiency of the antenna element 12 operating in the GSM850/900 bands (from about 824 MHz to 960 MHz), and the antenna efficiency curve 32 represents the antenna efficiency of the antenna element 12 operating in the GSM1800/1900/UMTS/LTE2300/2500 bands (from about 1710 to 2690 MHz). As shown in FIG. 3, the antenna element 12 has good antenna efficiency (S parameters have been included) in WWAN/LTE bands. In a preferred embodiment, the antenna efficiency is at least greater than about 65%, meeting the requirement for practical applications.

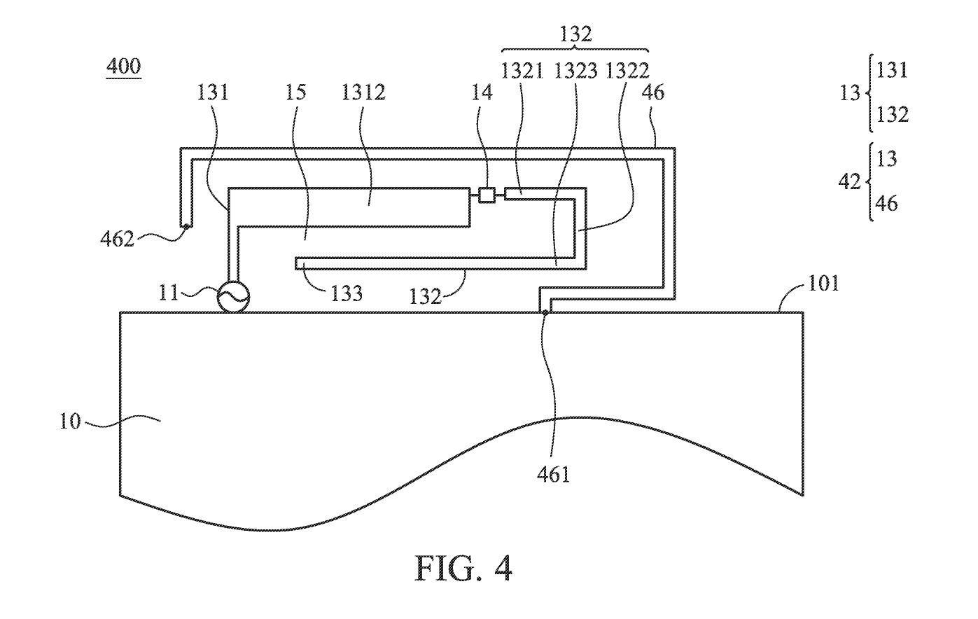

FIG. 4 is a diagram for illustrating a communication device 400 according to a second embodiment of the invention. The second embodiment is similar to the first embodiment. The main difference between the two embodiments is that a second radiation element 46 of an antenna element 42 of the communication device 400 extends and substantially surrounds the first radiation element 13. Other features of the communication device 400 in the second embodiment are similar to those in the first embodiment. Accordingly, the performance of the communication device 400 in the second embodiment is almost the same as that in the first embodiment.

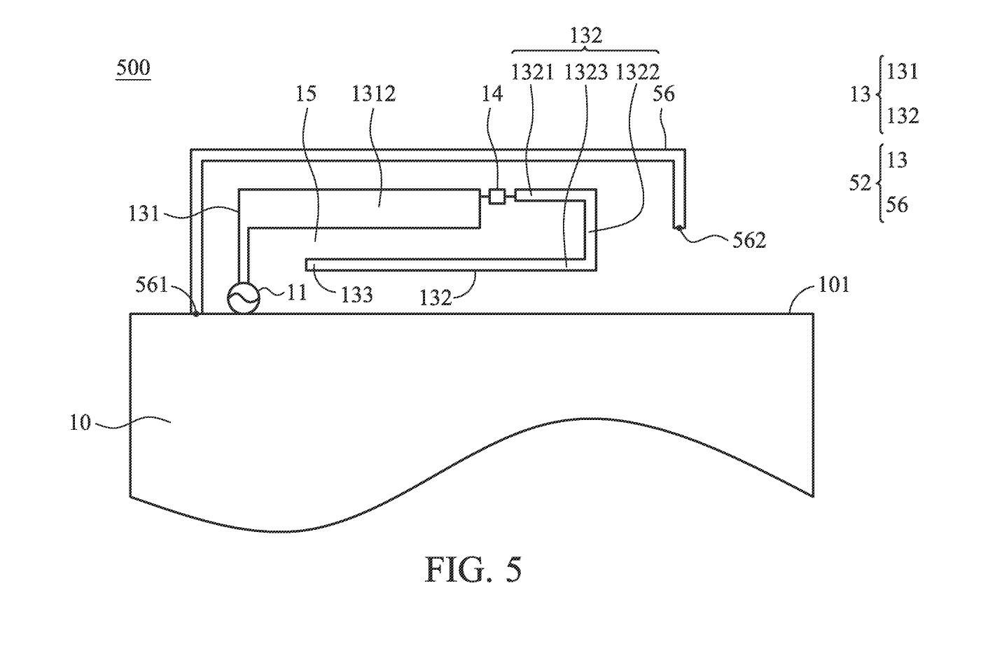

FIG. 5 is a diagram for illustrating a communication device 500 according to a third embodiment of the invention. The third embodiment is similar to the first embodiment. The main difference between the two embodiments is that a shorted end 561 of a second radiation element 56 of an antenna element 52 of the communication device 500 is adjacent to the signal source 11. The second radiation element 56 extends and substantially surrounds the first radiation element 13. Other features of the communication device 500 in the third embodiment are similar to those in the first embodiment. Accordingly, the performance of the communication device 500 in the third embodiment is almost the same as that in the first embodiment.

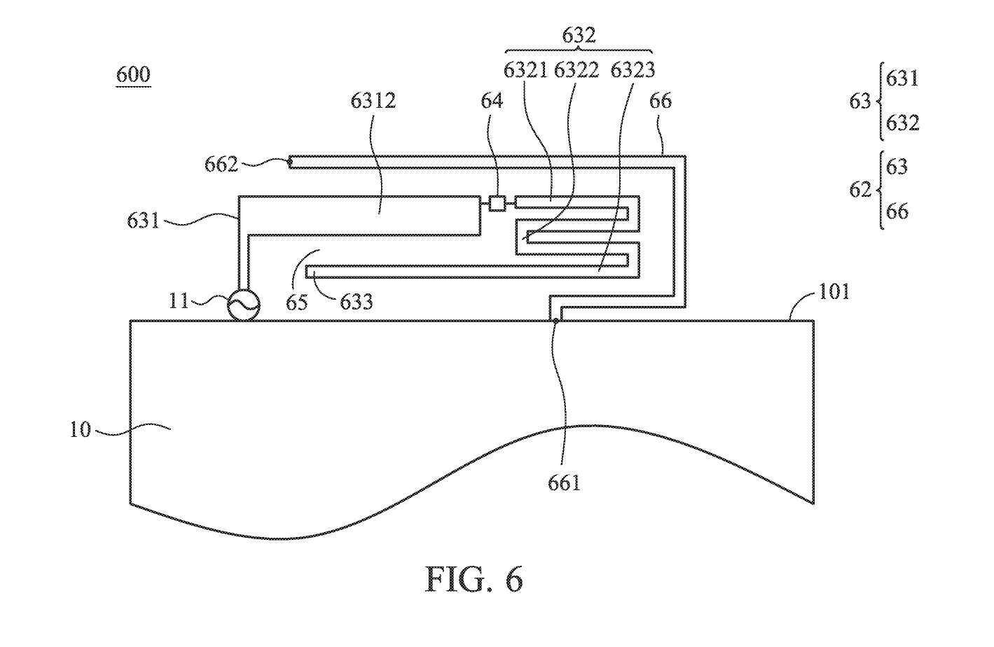

FIG. 6 is a diagram for illustrating a communication device 600 according to a fourth embodiment of the invention. The fourth embodiment is similar to the first embodiment. The main difference between the two embodiments is that a second portion 632 of a first radiation element 63 of an antenna element 62 of the communication device 600 comprises more (e.g., 6) bends to increase the effective inductance. The second portion 632 may substantially have a W-shape. The bends of the second portion 632 cause the second portion 632 to comprise a first segment 6321, a second segment 6322 and a third segment 6323. The first segment 6321 is substantially parallel to the third segment 6323, and the second segment 6322 is substantially perpendicular to the first segment 6321 and the third segment 6323. A coupling gap 65 between the second portion 632 and a first portion 631 of the first radiation element 63 generates an effective capacitance. Owing to the effective inductance and the effective capacitance, the antenna element 62 can generate a parallel resonance near a lower band. The design leads to an additional resonant mode in the lower band of the antenna element 62, and the antenna element 62 can achieve wide-band operation of the lower band. Other features of the communication device 600 in the fourth embodiment are similar to those in the first embodiment. Accordingly, the performance of the communication device 600 in the fourth embodiment is almost the same as that in the first embodiment.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A communication device, comprising:
a ground element; and
an antenna element, disposed adjacent to the ground element, wherein the antenna element comprises:
a first radiation element, comprising a first portion and a second portion, wherein the first portion is coupled through an inductive element to the second portion, the first portion is coupled to a signal source, the second portion comprises a plurality of bends such that a coupling gap is formed between an open end of the second portion and the first portion; and
a second radiation element, wherein the second radiation element has a shorted end and an open end, the shorted end is coupled to the ground element, and the second radiation element extends and at least partially surrounds the first radiation element.

2. The communication device as claimed in claim 1, wherein the first portion of the first radiation element comprises at least one bend such that at least one segment of the first portion is substantially parallel to an edge of the ground element.

3. The communication device as claimed in claim 1, wherein the first portion substantially has an inverted L-shape.

4. The communication device as claimed in claim 1, wherein the open end of the second portion of the first radiation element is substantially located between the first portion of the first radiation element and the ground element.

5. The communication device as claimed in claim 1, wherein a length of the second portion is greater than a half of a length of the first portion.

6. The communication device as claimed in claim 1, wherein a length of the second radiation element is greater than a length of the first portion.

7. The communication device as claimed in claim 1, wherein the shorted end of the second radiation element is adjacent to the signal source.

8. The communication device as claimed in claim 1, wherein the second portion substantially has a W-shape.

9. The communication device as claimed in claim 1, wherein the bends of the second portion of the first radiation element cause the second portion to comprise a first segment, a second segment and a third segment, wherein the first segment is substantially parallel to the third segment, and the second segment is substantially perpendicular to the first segment and the third segment.
